(19) United States
(12) Patent Application Publication
(10) Pub. No.: US 2009/0307451 A1
(43) Pub. Date: Dec. 10, 2009

(54) DYNAMIC LOGICAL UNIT NUMBER CREATION AND PROTECTION FOR A TRANSIENT STORAGE DEVICE

(75) Inventors: David Abzarian, Kirkland, WA (US); Harish S. Kulkarni, Redmond, WA (US); Todd L. Carpenter, Monroe, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/262,134

(22) Filed: Oct. 30, 2008

Related U.S. Application Data
(60) Provisional application No. 61/060,427, filed on Jun. 10, 2008.

(51) Int. Cl. G06F 12/14; G06F 12/00

(52) U.S. Cl. 711/163; 711/170; 713/193; 711/E12.001; 711/E12.092; 711/E12.093

(57) ABSTRACT

A dynamic logical unit number system is implemented as a storage device that includes processing logic and storage functionality. A storage device may be configured to provide a first logical unit number when the storage device is attached to a computer system or other computing device. The storage device through its dynamic logical unit number system provides a configuration interface through which the computer system can configure additional logical unit numbers and reconfigure existing logical unit numbers of the storage device. After the redefinition of the logical unit numbers, the dynamic logical unit number system may cause a reestablishment of the connection between the storage device and the computer system. Upon establishing the new connection, the computer system recognizes the redefined logical unit numbers and treats each logical unit number as a separate storage device, including assigning a different number to each logical unit number.

### CROSS REFERENCE TO RELATED APPLICATION

This application claims the benefit of U.S. Provisional Application No. 61/060,427, filed Jun. 10, 2008, and entitled “SECURE LOGICAL UNIT NUMBER BASED ACCESS TO A STORAGE DEVICE,” which is incorporated herein in its entirety by reference.

### BACKGROUND

Transient storage devices, such as Universal Serial Bus (“USB”) storage devices, have become increasingly common because, in part, of the simplicity of connecting and disconnecting such transient storage devices to various computer systems. For example, a user can connect a transient storage device to a computer system, copy files to the transient storage device, disconnect the transient storage device from the computer system, and connect the transient storage device to another computer system, which can then access the copied files. Because of the portable nature of such storage devices, they are particularly susceptible to being lost or stolen. Unless the storage device is somehow protected, a malicious user who gains access to a transient storage device can connect it to their computer and access the files stored on the transient storage device.

Various software and hardware solutions have been developed by software developers and by manufacturers of transient storage devices to help secure the data stored on transient storage devices. These solutions, however, have various limitations. Software solutions typically require platform-specific encryption software to protect the data. The use of encryption software limits the portability of the transient storage device, as the device can only be accessed by a computer system that includes the encryption software. Moreover, since the encrypted data is easily accessible by any computer system, it is susceptible to a brute force decryption attack. If a software solution is stored on the storage device itself, then it is susceptible to being modified by a malicious user or malicious software. Hardware solutions present different limitations. Hardware solutions do not provide different protection levels for the data of the storage device. In addition, hardware solutions map a single storage device to multiple logical storage devices for some operating systems. Such a mapping by operating systems has, however, resulted in less than desirable user experiences. Also, since the mapping to multiple logical storage devices is done by the manufacturer, the mapping may not meet the needs of some users.

### SUMMARY

A method and system for dynamically defining logical unit numbers of a transient storage device is provided. In some embodiments, a dynamic logical unit number system is implemented as part of a storage device that includes processing logic and storage functionality. As provided by a manufacturer, a storage device may be configured to provide a first logical unit number when the storage device is attached to a computer system or other computing device. After a connection is established, the computer system may be able to access the first logical unit number as it would a conventional transient storage device. The storage device through its dynamic logical unit number system provides a configuration interface through which the computer system can configure additional logical unit numbers and reconfigure existing logical unit numbers of the storage device. After the redefinition of the logical unit numbers, the dynamic logical unit number system may cause a reestablishment of the connection between the storage device and the computer system. Upon establishing the new connection, the computer system will recognize the redefined logical unit numbers and treat each logical unit number as a separate storage device, including assigning a different number to each logical unit number.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates a logical organization of components of a storage device in some embodiments.

FIG. 2 is a block diagram that illustrates a logical organization of components of a storage device in some embodiments.

FIG. 3 is a block diagram that illustrates a logical representation of a logical unit number mapping table in some embodiments of the dynamic logical unit number system.

FIG. 4 is a block diagram that illustrates a logical representation of a permission table in some embodiments of the dynamic logical unit number system.

FIG. 5 is a block diagram that illustrates a logical representation of a behavior table in some embodiments of the dynamic logical unit number system.

FIG. 6 is a flow diagram that illustrates the processing of an initialize device component in some embodiments of the dynamic logical unit number system.

FIG. 7 is a flow diagram that illustrates the processing of a set owner component in some embodiments of the dynamic logical unit number system.

FIG. 8 is a flow diagram that illustrates the processing of an authenticate component of the logical unit number system in some embodiments of the dynamic logical unit number system.

FIG. 9 is a flow diagram that illustrates the processing of a create logical unit number component in some embodiments of the dynamic logical unit number system.

FIG. 10 is a flow diagram that illustrates the processing of a set behavior component in some embodiments of the dynamic logical unit number system.

FIG. 11 is a flow diagram that illustrates the processing of a read component in some embodiments of the dynamic logical unit number system.

### DETAILED DESCRIPTION

A method and system for dynamically defining logical unit numbers of a transient storage device is provided. In some embodiments, a dynamic logical unit number system is implemented as part of a storage device that includes processing logic and storage functionality. As provided by a manufacturer, a storage device may be configured to provide a first logical unit number when the storage device is attached (i.e., physically connected) to a computer system. When the storage device is attached to a computer system, a connection is established between the first logical unit number and the computer system. After the connection is established, the computer system may be able to access the first logical unit number as it would a conventional transient storage device. The storage device through its dynamic logical unit number system provides a configuration interface through which the computer system can configure additional logical unit numbers and reconfigure existing logical unit numbers of the storage device. For example, if a storage device includes 1024 blocks of storage, the dynamic logical unit number system allows for a first logical unit number to be defined that is assigned blocks 0 through 255 and a second logical unit number to be defined that is assigned blocks 256 through 1023. After the redefinition of the logical unit numbers, the dynamic logical unit number system may cause a reestablishment of a connection between the storage device and the computer system. For example, a connection may be reestablished by the dynamic logical unit number system emulating a detaching and reattaching of the storage device to the computer system. When the reattachment occurs, a new connection is established between the storage device and the computer system. Upon establishing the new connection, the computer system will recognize the redefined logical unit numbers and treat each logical unit number as a separate storage device, including assigning a different number to each logical unit number. In this way, the dynamic logical unit number system allows a storage device to be dynamically reconfigured to accommodate various needs of users. In some embodiments, the dynamic logical unit number system may provide the configuration interface through a primary logical unit number, rather than a separately defined interface. In such an embodiment, the primary logical unit number would always be defined so that the configuration interface could be accessed.

In some embodiments, the dynamic logical unit number system may allow an owner, provisioner, or administrator of a storage device to be specified when the storage device is attached to a computer system. For example, when a user first attaches a new storage device to their computer system, the user may specify that the user is the owner of the storage device. Once the owner is specified, the owner may have the authorization to control all configuration aspects of the storage device and to set permissions for other users to access the storage device. For example, the owner of a storage device may be allowed to redefine the various logical unit numbers, define partitions within logical unit numbers, establish an access control list for each logical unit number or partition, specify various behaviors that a logical unit number is to exhibit, and so on. The dynamic logical unit number system may employ an authentication mechanism to authenticate an entity attempting to access the storage device. For example, when the owner of a storage device is specified, the dynamic logical unit number system may store an identifier of the owner in a portion of the storage device that is not accessible to the computer system to which it is attached. When a connection is established to the computer system, the computer system may provide authentication information to the dynamic logical unit number system. For example, when the owner is initially specified, a password may be provided to the dynamic logical unit number system. When an entity provides that same password, then the dynamic logical unit number system authenticates the entity as the owner. As another example, the owner may be authenticated using the public key infrastructure (“PKI”) using asymmetric keys or may be authenticated using a symmetric key. To be authenticated, an entity may provide their signature to the storage device. The dynamic logical unit number system may obtain a certificate for the owner (e.g., from the entity itself or a certificate server). The dynamic logical unit number system may then verify the certificate via the public key infrastructure. If the certificate is verified and is for the owner, then the public key of the certificate may be used to validate the signature, which represents an encryption using the corresponding public key. If the signature is valid, then the dynamic logical unit number system authenticates the entity as the owner. Similar authentication mechanisms may be used to authenticate entities that the owner has authorized to access the storage device. The storage system stores an indication of the authenticated entity in a nonpersistent manner. Thus, when the storage device is disconnected (or detached) from the computer system and then reconnected to that or another computer system, the entity would need to be reauthenticated. Although the owner can configure the storage device via the configuration interface, the owner may not have access to any of the resources (e.g., partitions and data blocks) of the logical unit numbers.

In some embodiments, the dynamic logical unit number system allows an authorized entity to define partitions within each logical unit number of a storage device. Each partition may be assigned a set of contiguous blocks within a logical unit number, which itself may contain contiguous blocks. Blocks may be considered contiguous when they have sequential addresses within the address space of the storage device. Each partition may inherit the attributes associated with the logical unit number such as permissions of the logical unit number.

In some embodiments, the dynamic logical unit number system may allow an authorized entity to establish permissions for controlling access of other entities to resources of a storage device. The resources of a storage device may include the storage device itself, a logical unit number, a partition, and so on. The dynamic logical unit number system may allow permissions to be established using a group-based model or a tree-based model. With a group-based model, groups of entities are given permissions and any entity within a group can access a resource in a manner that is consistent with the permissions of the group. When a new member is added to a group, it inherits the permissions of the group. With a tree-based model, entities are given permissions to access a resource and can grant access to child entities to access the resource with the same set or a subset of their permissions. When a new child entity is defined, it inherits by default the permissions of its parent. When a new partition is defined for a logical unit number, the permissions of the partition are inherited from the logical unit number. Thus, with the group-based model, the members of the groups that have permissions defined for that logical unit number have by default the same permissions defined for the partition. Similarly, with the tree-based model, a parent and child entities that have permissions to the logical unit number have by default the same permission defined for the partition. The permissions may include, for example, read/write access, read-only access, and execute access to a resource. For example, the owner of a storage device may specify that user 1 has read/write permission and execute permission to a certain logical unit number and that user 2 has read-only permission and execute permission to that certain logical unit number. Once an entity has been authenticated as being user 1 or user 2, the dynamic logical unit number system limits access to the resources of the storage system based on the specified permissions. The dynamic logical unit number system may also allow permissions to be specified for entities that cannot be authenticated. For example, the owner of the storage device may specify that an entity that is not authenticated has only execute permission to a certain logical unit number. Thus, if the storage device is attached to a computer system that has not been adapted to take advantage of the features of the dynamic logical unit number system, the computer system may still access resources of the storage device in accordance with the permissions specified for a nonauthenticated entity.

In some embodiments, the dynamic logical unit number system may allow the owner or other authorized entity to specify behaviors of a resource of a storage device. For example, the behaviors may include write caching, write protected, IEEE 1667 enabled, and so on. When a new behavior of a storage system is specified, the dynamic logical unit number system persistently stores an indication of the behavior within an area of the storage device that is not accessible to the computer system to which it is attached. Because the computer system recognizes the behavior of a storage device when a connection is established, the dynamic logical system effects the reestablishment of the connection when a different behavior is specified. When the connection is reestablished, the dynamic logical unit number system checks the specified behaviors and effects an implementation of those behaviors so that the computer system recognizes the different behaviors.

In some embodiments, the dynamic logical unit number system may use various techniques to reestablish a connection with a computer system. For example, the dynamic logical unit number system may stimulate a detachment and reattachment of the storage system to the computer system. When the reattachment is simulated, the computer system recognizes attributes of the storage device including the currently defined logical unit numbers and behaviors. As another example, an interface may be defined through which the dynamic logical unit number system notifies the computer system that its behavior has changed or notifies the computer system to perform the processing that is normally performed when a storage device is attached to the computer system. In particular, the computer system can tear down the existing logical unit numbers and rebuild them in accordance with the reconfiguration of the storage device.

In some embodiments, the dynamic logical unit number system may allow an authorized entity to specify that certain resources of a storage system are to have their data stored in an encrypted format. The dynamic logical unit number system may persistently store encryption/decryption keys in an area of the storage device that is not accessible to the computer system or may be provided with encryption/decryption keys when a connection is established with a computer system. When the encryption/decryption keys are stored persistently, the dynamic logical unit number system may perform the encryption and decryption in a manner that is transparent to an application program of a computer system that is accessing the storage device so long as the dynamic logical unit number system determines that the authenticated entity accessing the storage device is authorized to access the encrypted resource. When the keys are not stored persistently, the dynamic logical unit number system may decrypt data using decryption keys provided by the computer system. If a malicious user were to attempt to access the storage device, because the malicious user would likely not have read permission, the dynamic logical unit number system would not provide even the encrypted data of the resource to the user. Thus, the malicious user could not even attempt a brute force decryption of the encrypted data. The encryption of a resource may be considered a behavior of the resource.

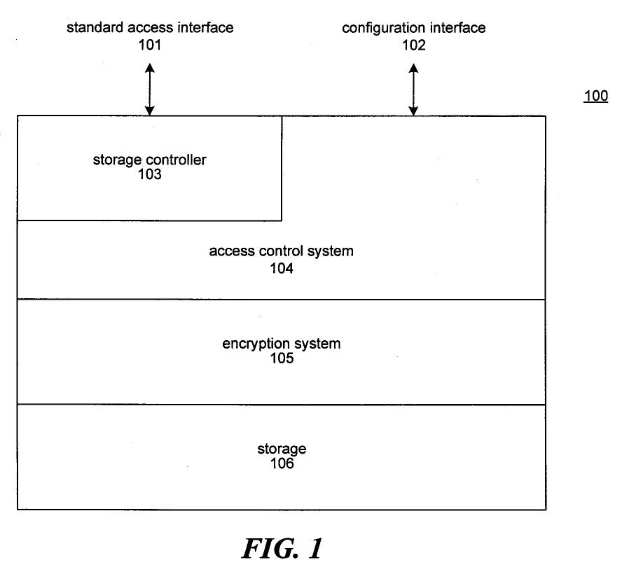

FIG. 1 is a block diagram that illustrates a logical organization of components of a storage device in some embodiments. The storage device 100 provides a standard access interface 101 and a configuration interface 102. The standard access interface provides a conventional interface, such as a USB interface, through which a computer system accesses the storage of the storage device. Because the storage device provides such a standard access interface, once a storage device is attached to a computer system, the computer system has access to resources of the device as a nonauthenticated entity even though the computer system may be unaware that the storage device is a storage device. The configuration interface, however, allows a computer system that is aware of the dynamic nature of the storage device to configure it, to provide authentication information, and to establish permissions and behaviors. The storage device provides a storage controller 103, an access control system 104, and an encryption system 105, which together comprise an implementation of the dynamic logical unit number system. The storage controller provides the standard access interface. The access control system provides the configuration interface and ensures that access to a storage 106 through the storage controller is consistent with the configuration, permissions, and behaviors. The encryption system provides the capability for encrypting and decrypting resources in a manner that is transparent to accesses through the standard access interface. The storage contains the storage area that is available to computer systems and may include internal storage that is accessible only to the dynamic logical unit number system.

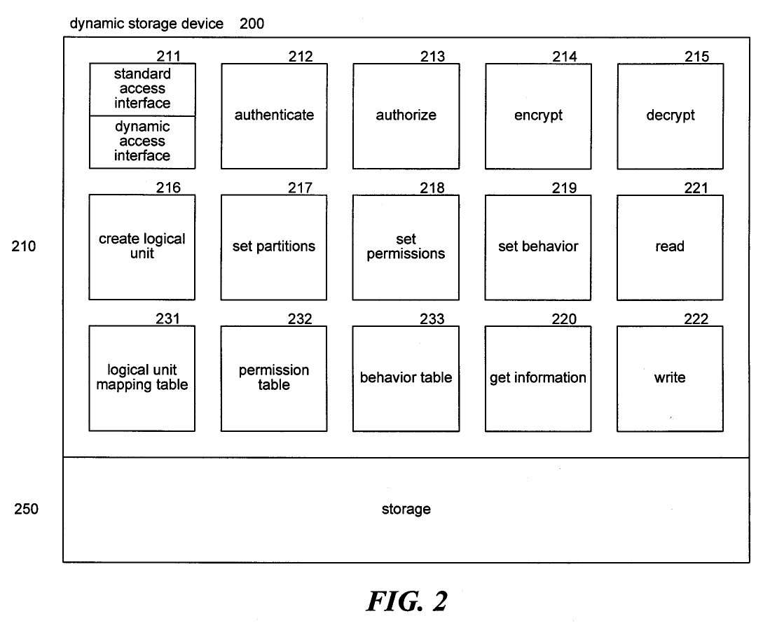

FIG. 2 is a block diagram that illustrates a logical organization of components of a storage device in some embodiments. The storage device 200 may include components 210 and storage 250. The components may include an access interfaces 211, an authenticate component 212, an authorize component 213, an encrypt component 214, a decrypt component 215, a create logical unit number component 216, a set partitions component 217, a set permissions component 218, a set behavior component 219, a get information component 220, a read component 221, a write component 222, and other components described below but not illustrated in FIG. 2. The access interface may implement the standard access interface and the configuration interface as described above. The authenticate component may authenticate an entity that has provided authentication information via the configuration interface. If the entity is successfully authenticated, the authenticate component nonpersistently stores an indication that that entity has been authenticated during the current connection between the storage device and the computer system. The authorize component determines whether an attempted access to a resource by an entity is consistent with the permissions for that resource. A resource may be accessed via the standard access interface or the configuration interface. The encrypt and decrypt components control the encryption and decryption of the data of a resource. The create logical unit number component controls the configuring of the logical unit numbers of the storage system. The set partitions component controls the specifying of partitions within a logical unit number. The set permissions component controls the setting of permissions of the resources in a manner that is consistent with the specified permission model for that resource. The set behavior component sets the attribute of a resource so that the resource exhibits a desired behavior. The get information component retrieves information (e.g., permissions and configuration) requested by the computer system via the configuration interface. The read and write components are used to access storage of the storage device.

The components of the storage device 200 also include a logical unit number mapping table 231, a permission table 232, and a behavior table 233. The logical unit number mapping table contains a mapping of blocks of the storage to the logical unit numbers of the device and of blocks within a logical unit number to partitions within the logical unit number. The permission table contains permissions that control access to resources of the device. The behavior table contains attributes indicating the behavior that the resources of the device are to exhibit. One skilled in the art will appreciate that multiple functions of the storage device can be integrated into a single component, separated into multiple components, or subdivided in various ways.

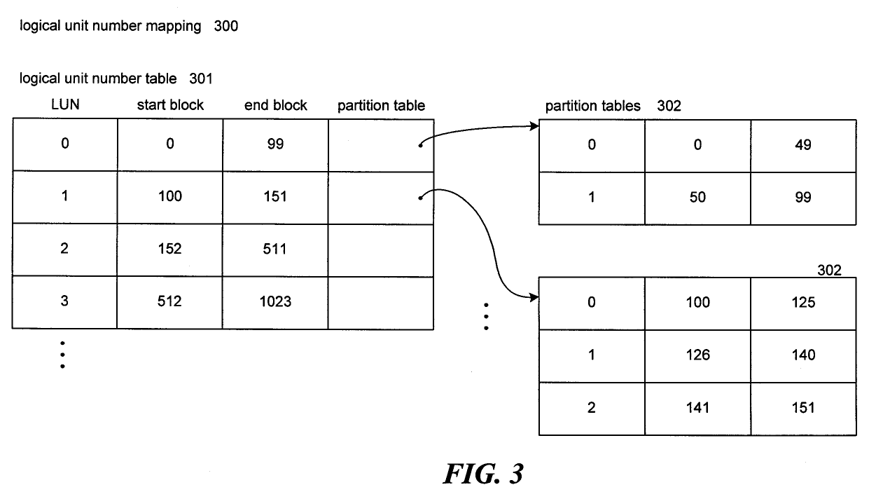

FIG. 3 is a block diagram that illustrates a logical representation of a logical unit number mapping table in some embodiments of the dynamic logical unit number system. The logical unit number mapping table 300 includes a logical unit number table 301 and partition tables 302. The logical unit number table contains an entry for each logical unit number that has been specified for the device. In this example, four logical unit numbers with numbers 0 through 3 have been defined. Each entry includes the logical unit number, the start block number, the end block number, and a reference to a partition table for that logical unit number. For example, the logical unit number with a logical unit number of 1 has a start block number of 100 and an end block number of 151. Each partition table contains an entry for each partition, if any, that has been defined for the referencing logical unit number. Each entry includes the partition number, the start block number, and the end block number of the partition. For example, the entry for partition 2 of the partition table of logical unit number 1 has a start block number of 141 and an end block number of 151.

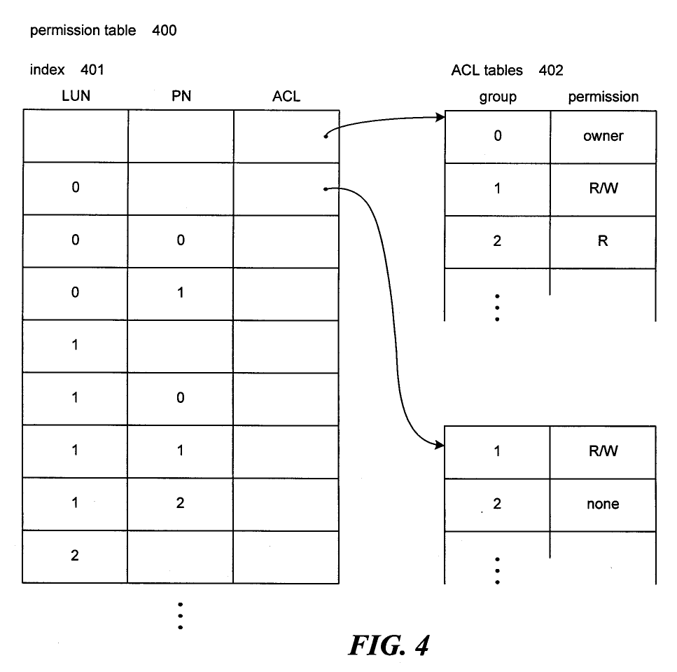

FIG. 4 is a block diagram that illustrates a logical representation of a permission table in some embodiments of the dynamic logical unit number system. The permission table 400 may include an index 401 and access control (“ACL”) tables 402. The permission table contains an entry for each access control list that has been defined for a resource of the storage device. Each entry may contain a logical unit number, a partition number, and a reference to an ACL table. An entry with a blank logical unit number and a blank partition number may represent a resource that is the storage device itself. An entry with a logical unit number and a blank partition number may represent a resource that is a logical unit number. An entry with a logical unit number and a partition number may represent a resource that is a partition of a logical unit number. Each ACL table contains an entry for each group (assuming a group-based permission model) with permissions for accessing the referencing (i.e., associated) resource. For example, the access control table for the storage device itself contains an entry for groups 0, 1, and 2. Each entry identifies a group and the permissions that the group has to the associated resource. For example, the entities of group 0 have owner permission to the storage device, and the entities of group 1 have read/write access to the storage device. Although not illustrated, the dynamic logical unit number system maintains tables indicating the entities that belong to each group that may be defined by the owner or a delegate of the owner.

Alternatively, since a partition may inherit the permissions of its logical unit number, the permission table may not have an entry for a partition of a logical unit number. In such a case, the dynamic logical unit number system may use the permissions of the logical unit number that contains that partition as the permissions for the partition. In some embodiment, the dynamic logical unit number system may not even allow separate permissions to be defined for each partition.

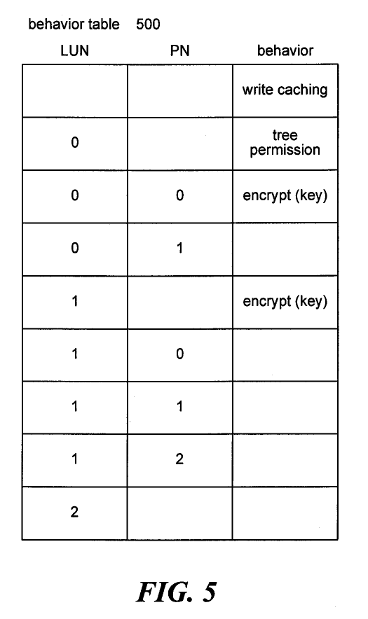

FIG. 5 is a block diagram that illustrates a logical representation of a behavior table in some embodiments of the dynamic logical unit number system. The behavior table 500 includes an entry for each resource whose behavior can be specified. Each entry may identify the resource (e.g., logical unit number and partition number) and specify its behaviors. For example, the entry with a blank logical unit number and a blank partition number may represent the storage device itself. In this example, the storage device itself has a behavior of write caching, and partition 0 of logical unit number 0 has a behavior of encrypted.

The computing devices to which a storage device may be attached may include a central processing unit, memory, input devices (e.g., keyboard and pointing devices), output devices (e.g., display devices), and storage devices (e.g., disk drives). The memory and storage devices are computer-readable storage media that may contain instructions that implement functionality to access the storage device. In addition, the data structures and message structures may be transmitted via a computer-readable data transmission medium, such as a signal on a communications link. Various communications links may be used, such as the Internet, a local area network, a wide area network, or a point-to-point dial-up connection. The computer-readable media include computer-readable storage media and computer-readable data transmission media.

A dynamic data storage device may be used in various operating environments. The operating environment described herein is only one example of a suitable operating environment and is not intended to suggest any limitation as to the scope of use or functionality of the dynamic logical unit number system. Other well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The dynamic logical unit number system may be described in the general context of computer-executable instructions, such as program modules, executed by one or more processors or other devices. The dynamic logical unit number system may include a processor adapted to perform the functionality of the storage system. Generally, program modules include routines, programs, objects, components, data structures, etc., that perform particular tasks or implement particular abstract data types. Typically, the functionality of the program modules may be combined or distributed as desired in various embodiments. The functionality of various program modules may also be implemented via hardwired electronic circuitry and as code for a micro controller.

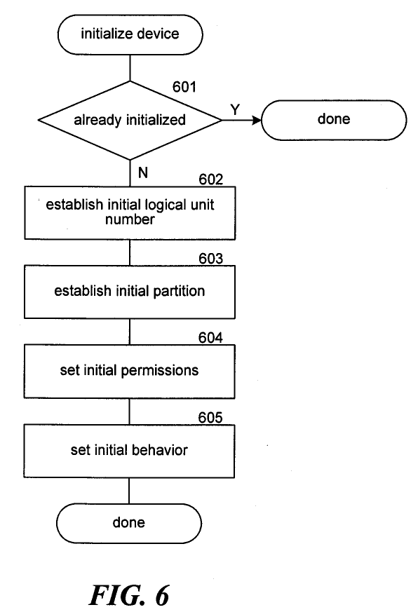

FIG. 6 is a flow diagram that illustrates the processing of an initialize device component in some embodiments of the dynamic logical unit number system. The component may be invoked when a storage device is initially attached to a computer system. The component is responsible for initializing the device. Alternatively, the initialization may be performed as part of the manufacturing process of the device. In block 601, if the device has already been initialized, then the component completes, else the component continues at block 602. In block 602, the component establishes an initial logical unit number by initializing the logical unit number table. In block 603, the component establishes an initial partition within the initial logical unit number by initializing a partition table for the initial logical unit number. In block 604, the component sets the initial permissions for the device, the initial logical unit number, and the initial partition. For example, the initial permission may be that any entity, authenticated or not, has access to all resources. In block 605, the component sets the initial behavior of the device and then completes.

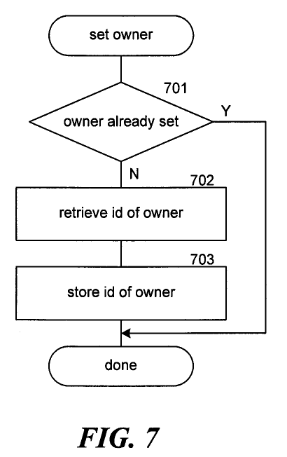

FIG. 7 is a flow diagram that illustrates the processing of a set owner component in some embodiments of the dynamic logical unit number system. The component may be invoked when the configuration interface receives requests from the computer system to set the owner of the storage device. The component may be passed the identification of the owner. In decision block 701, if an owner has already been set, then the component completes, else the component continues at block 702. In block 702, the component retrieves the identifier of the owner. In block 703, the component stores the identifier of the owner persistently within the storage device and then completes. Subsequently, an entity that is authenticated as the owner will have full control over controllable features of the storage device.

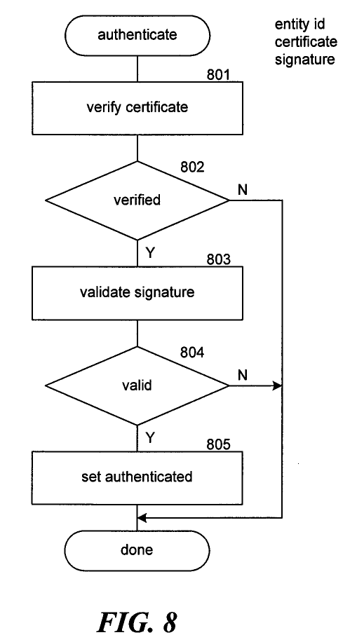

FIG. 8 is a flow diagram that illustrates the processing of an authenticate component of the logical unit number system in some embodiments of the dynamic logical unit number system. The component is invoked when the computer system requests to authenticate an entity via the configuration interface. The component may be passed an identifier of the entity to be authenticated, a certificate for that entity, and a signature of that entity. In block 801, the component verifies the certificate using, for example, the public key infrastructure, which may be accessible via the computer system. In decision block 802, if the certificate has been verified, then the component continues at block 803, else the component completes because the entity cannot be authenticated. In block 803, the component validates the signature to ensure that it was generated using the private key corresponding to the public key of the verified certificate. In decision block 804, if the signature is valid, then the component continues at block 805, else the component completes because the entity cannot be authenticated. In block 805, the component sets a nonpersistent indicator indicating that the entity with the passed identifier has been authenticated and then completes. Subsequently, additional entities may be authenticated during the same connection. In such a case, the nonpersistent indicator may be overwritten or additional nonpersistent indicators may be stored. If the component stores additional nonpersistent indicators, then access to the device may be allowed if any of the authenticated entities have permission to perform the access.

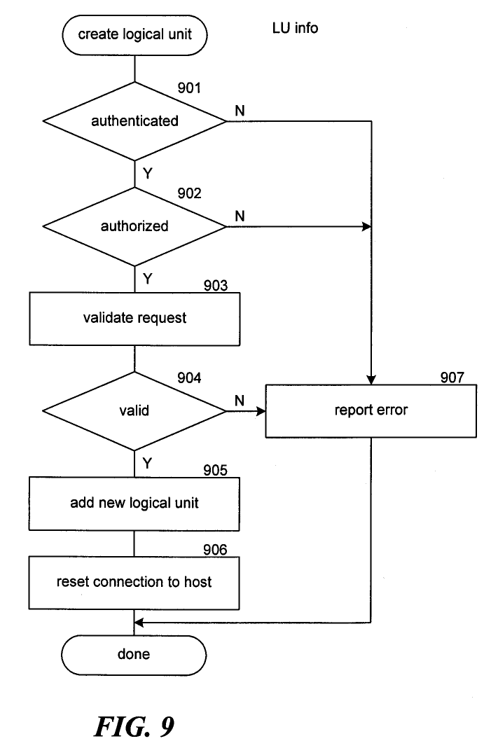

FIG. 9 is a flow diagram that illustrates the processing of a create logical unit number component in some embodiments of the dynamic logical unit number system. The component may be invoked when a computer system requests via the configuration interface to respecify logical unit numbers of the device. The component is passed logical unit number information specifying the redefinition of the logical unit numbers. In decision block 901, if an entity has been authenticated or no authentication is required (e.g., owner not yet set), then the component continues at block 907, else the component continues at block 902. In decision block 902, if the entity accessing the device is authorized to create a logical unit number as indicated by the permissions, then the component continues at block 903, else the component continues at block 907. In block 903, the component validates the request to ensure that the configuration can be implemented. In decision block 904, if the request is valid, then the component continues at block 905, else the component continues at block 907. In block 905, the component creates a new logical unit number as specified by the passed logical unit number information. In block 906, the component reestablishes the connection with the computer system so that the computer system will recognize the new logical unit number and then completes. In block 907, the component reports an error and then completes.

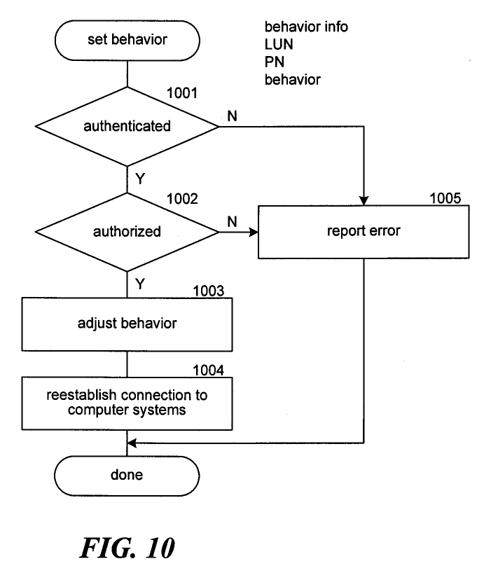

FIG. 10 is a flow diagram that illustrates the processing of a set behavior component in some embodiments of the dynamic logical unit number system. The component is passed behavior information that may include a logical unit number, a partition number, and a behavior attribute. The component sets the behavior for the resource identified by the logical unit number and partition. In decision block 1001, if an entity has been authenticated, then the component continues at block 1002, else the component continues at block 1005. In decision block 1002, if the entity is authorized to set the behavior, then the component continues at block 1003, else the component continues at block 1005. In block 1003, the component sets the behavior attribute for the resource identified by the behavior information. In block 1004, the component reestablishes a connection to the computer system so that the computer system recognizes the new behavior and then completes. The component also initializes the state of the storage device (e.g., clears indications of currently authenticated entities). In block 1005, the component reports an error and then completes.

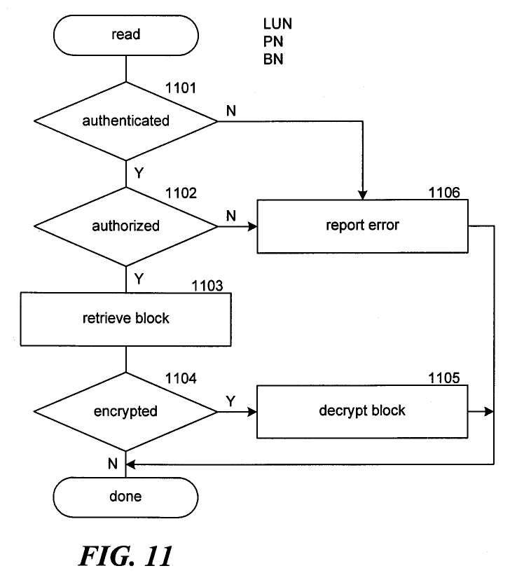

FIG. 11 is a flow diagram that illustrates the processing of a read component in some embodiments of the dynamic logical unit number system. The component may be passed a logical unit number, a partition number, and a block number of the block that is to be read. The component may be invoked when a read request is received via the standard access interface. In decision block 1101, if an entity has been authenticated, then the component continues at block 1102, else the component continues at block 1106. In block 1102, if the authenticated entity is authorized to read the requested block, then the component continues at block 1103, else the component continues at block 1106. In block 1103, the component retrieves the block. In decision block 1104, if the block is encrypted, then the component continues at block 1105, else the component completes. In block 1105, the component decrypts the block and then completes. In block 1106, the component reports an error and then completes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims. Accordingly, the invention is not limited except as by the appended claims.

I/We claim:

1. A method in a storage device for dynamically defining a logical unit number, the method comprising:
providing a storage device configured to define a first logical unit number, the first logical unit number being assigned first blocks of the storage device;
establishing a connection with a computing device such that the computing device recognizes that the storage device provides the first logical unit number; and
after establishing the connection with the computing device,
receiving from the computing device a request to define a second logical unit number for the storage device, the second logical unit number being specified by second blocks of the storage device that are to be assigned to the second logical unit number;
configuring the storage device to assign the second blocks of the storage device to the second logical unit number; and
reestablishing a connection with the computing device so that the computing device recognizes that the storage device provides the first logical unit number and the second logical unit number.

2. The method of claim 1 wherein the storage device is a USB-compatible device that provides a standard access interface and a configuration interface.

3. The method of claim 1 including:
receiving from the computing device a request to specify an owner of the storage device, the request specifying an identification of the owner; and
storing the identification of the owner.

4. The method of claim 3 including:
receiving from the computing device a request to authenticate an entity for access to the storage device, the request including an electronic signature;
validating that the electronic signature of the request is the electronic signature of the owner; and
when the electronic signature is validated as being the electronic signature of the owner, allowing authenticated access to the storage device.

5. The method of claim 4 wherein the validating of the electronic signature includes verifying a certificate of the owner via a public key infrastructure.

6. The method of claim 1 including:
receiving from the computing device access control information specifying an entity that has limited access rights to a resource of the storage device;
storing the received access control information; and
upon receiving from the computing device a request to access the resource unit on behalf of the entity, allowing access to the resource in accordance with the limited access rights specified in the stored access control information.

7. The method of claim 1 including:
receiving from the computing device behavior information for a resource of the storage device, the behavior information specifying a behavior that the resource is to exhibit;
storing an indication of the received behavior information; and
reestablishing a connection with the computing device so that the computing device recognizes that the resource exhibits the behavior specified by the stored behavior information.

8. The method of claim 1 wherein the reestablishing of the connection includes simulating a detachment of the storage device from the computing device followed by simulating a reattachment of the storage device to the computing device.

9. The method of claim 1 wherein the reestablishing of the connection includes notifying the computing device to reestablish the connection.

10. The method of claim 1 including:
receiving from the computing device a request to store data of a resource of the storage device in encrypted form;
receiving from the computing device an encryption key; and
when a request is received from the computing device to store data of the resource, encrypting the data with the received encryption key and storing the encrypted data of the resource.

11. The method of claim 10 including persistently storing the encryption key in the storage device.

12. The method of claim 10 including:
persistently storing a decryption key in the storage device; and
when a request is received from the computing device to read data of the resource on behalf of an entity and when the entity is authenticated and authorized to access the resource as requested, decrypting data of the resource using the decryption key and providing the decrypted data to the computing device.

13. A storage device with a processor and blocks of storage, the storage device comprising:
an access control system that provides a configuration interface through which a computing device can dynamically configure logical unit numbers of the storage device, can reestablish a connection with the computing device after a reconfiguration of the logical unit numbers so that the computing device can recognize the reconfigured logical unit numbers, and can specify encryption information for a logical unit number;
a storage controller providing a standard access interface through which the computing device accesses logical unit numbers of the storage device in accordance with a current configuration of the logical unit numbers of the storage device; and
an encryption system that encrypts and decrypts data being stored in and retrieved from storage of the storage device in accordance with the encryption information.

14. The storage device of claim 13 wherein the storage controller provides a USB-compatible standard access interface.

15. The storage device of claim 13 wherein the access control system further receives from the computing device a request to specify an owner of the storage device, the request specifying an identification of the owner, and the access control system persistently stores the identification of the owner.

16. The storage device of claim 15 wherein the access control system further receives from the computing device a request to authenticate an entity for access to the storage device, performs authentication for the entity, and, when the entity is authenticated as the owner, allows access to the storage of the dynamic device.

17. The storage device of claim 13 wherein the access control system further receives from the computing device access control information specifying an entity that has limited access rights to the storage device and stores the received access control information so that upon receiving from the computing device a request to access a certain logical unit number on behalf of the entity, the storage device allows access to the certain logical unit number in accordance with the limited access rights specified in the stored access control information.

18. A storage device with a processor and blocks of storage, the storage device comprising:
an access control system that provides a configuration interface through which a computing device dynamically configures logical unit numbers of the storage device and reestablishes a connection with the computing device after a reconfiguration of the logical unit numbers so that the computing device can recognize the reconfigured logical unit numbers; and
a storage controller that provides a standard access interface through which the computing device accesses logical unit numbers of the storage device in accordance with a current configuration of the logical unit numbers of the storage device.

19. The storage device of claim 18, further comprising an encryption system that encrypts and decrypts data being stored in and retrieved from storage of the storage device in accordance with encryption information received via the configuration interface.

20. The storage device of claim 18 wherein the computing device can dynamically configure partitions of a logical unit number through the configuration interface.
